(19) United States
(12) Patent Application Publication
(10) Pub. No.: US 2026/0017105 A1
(43) Pub. Date: Jan. 15, 2026

(54) ADAPTIVE SERVICE CONTAINER MANAGEMENT PLATFORM RESOURCE PLANNING, BUDGETING AND EXECUTION

(71) Applicant: Dell Products L.P., Round Rock, TX (US)

(72) Inventors: Jason Liu, Wellesley, MA (US); Fatemeh Azmandian, Raynham, MA (US); Vinay Sawal, Fremont, CA (US); Matthew R. Cullen, Derry, NH (US); Joachim N. Hansson, Monroe, WA (US); Deepak Krishna, Newcastle, WA (US); Sumeet Dhameja, Markham (CA); Devon Hopper, Snohomish, WA (US)

(21) Appl. No.: 18/768,543

(22) Filed: Jul. 10, 2024

(51) Int. Cl. G06F 9/50

(52) U.S. Cl. CPC G06F 9/5033

(57) ABSTRACT

The technology described herein is directed towards resource consumption forecasting, e.g., with KUBERNETES (K8S). Artificial intelligence/machine learning model-based forecasting of future resource needs can operate with respect to multi-cloud and hybrid cloud environments. Future resource consumption needs such as CPU/memory/disk/network usage is based on a weighted combination of historical resource consumption records, platform (e.g., K8S) configuration changes, target business demands and different software versions of the platform. Based on the forecasted resource consumption needs, IT departments can perform budget planning following the company's budget cycles. Different strategy level considerations such as minimizing total cost or maximizing delivery speed can be designed in resource plans. The system adapts to dynamic environment changes. Because budgeting in hybrid cloud and multi-cloud environments each have a different cost structure, different optimization policies can be applied, and resource needs can be divided into business cycles.

### BACKGROUND

Enterprises needs efficient information technology (IT) resource planning and budgeting to strategically allocate and utilize computing resources, such as CPU, memory, disk storage, and network capacity, for current operations and future growth. The adoption of cloud-based solutions, like hybrid cloud and multi-cloud environments, introduces complexities and challenges in managing resources across providers and anticipating future needs. Manual planning is labor-intensive and error-prone, leading to suboptimal resource utilization and increased costs.

In an automated system for deployment, scaling, and management of containerized applications, such as the open source service container management platform known as Kubernetes®, applications and services can be structured as containers within pods, which run among the nodes of a cluster. This can further complicate computing resource planning.

### BRIEF DESCRIPTION OF THE DRAWINGS

The technology described herein is illustrated by way of example and not limited in the accompanying figures in which like reference numerals indicate similar elements and in which:

FIGS. 1 and 2 comprise a block diagram representation of an example system that automates service container management platform resource planning and budgeting by forecasting, in accordance with various implementations and embodiments of the subject disclosure.

FIG. 3 is a graphical representation of example timeseries data representative of historical resource consumption records illustrating memory consumption over time, including with different numbers of nodes and software version changes, in accordance with various implementations and embodiments of the subject disclosure.

FIG. 4 is a graphical representation of timeseries training data and test data for central processing unit (CPU) usage forecasting based on prior CPU percentage usage over time, in accordance with various implementations and embodiments of the subject disclosure.

FIGS. 5A and 5B are graphical representations of example past and expected future increasing (linearly steady, FIG. 5A, and exponentially aggressive, FIG. 5B) system load predictions, in accordance with various implementations and embodiments of the subject disclosure.

FIGS. 6A and 6B are graphical representations of example past and expected future system load data, in accordance with various implementations and embodiments of the subject disclosure.

FIG. 7 is a representation of an example Bayesian network model for adjusting the weights of historical data for forecasting, in accordance with various implementations and embodiments of the subject disclosure.

FIGS. 8 and 9 are representations of example visualizations for forecasts, which can be used in conjunction with providing notifications, in accordance with various implementations and embodiments of the subject disclosure.

FIG. 10 is a representation of example recommendation of needed resources based in part on budget cycles, in accordance with various implementations and embodiments of the subject disclosure.

FIGS. 11A-11C are example graphical representations of execution and adjusting based on monitoring actual resource usage versus forecasted resource usage, in accordance with various implementations and embodiments of the subject disclosure.

FIG. 12 is a flow diagram showing example operations related to obtaining computing resource usage data from a forecasting model and outputting recommendation data based on the forecasted computing resource usage data, in accordance with various implementations and embodiments of the subject disclosure.

FIG. 13 is a flow diagram showing example operations related to obtaining CPU, memory and disk usage forecasts from a forecasting model and outputting recommendation data based on the forecasted CPU, memory and disk usage forecasts, in accordance with various implementations and embodiments of the subject disclosure.

FIG. 14 is a flow diagram showing example operations related to forecasting a future number of nodes of a cluster expected to be requested or needed with respect to a future timeframe based on a weighted combination of CPU, memory and disk usage forecasts, CPU, memory and disk usage increase ratio data, and estimated load increase ratio data, in accordance with various implementations and embodiments of the subject disclosure.

FIG. 15 is a block diagram representing an example computing environment into which the subject matter described herein may be incorporated and/or may communicate.

FIG. 16 depicts an example schematic block diagram of a computing environment with which the disclosed subject matter can interact/be implemented at least in part, in accordance with various implementations and embodiments of the subject disclosure.

### DETAILED DESCRIPTION

Various implementations and embodiments of the technology described herein are generally directed towards resource consumption forecasting, e.g., with KUBERNETES (K8S), that overcomes the need for a manual, labor-intensive resource estimation process as currently performed by human experts. As will be understood, the technology described herein, including artificial intelligence/machine learning (AI/ML) model-based forecasting of future resource needs, can operate with respect to multi-cloud and hybrid cloud environments, beyond mere cost monitoring functions.

In general, the technology described herein estimates future resource consumption needs (such as central processing unit (CPU)/memory/disk/network usage) based on a weighted combination of historical resource consumption records, platform (e.g., K8S) configuration changes as history (e.g., extra CPU added at second month, and the like), and target business demands as a goal to grow into (e.g., to support increasing customer loads). Further, different software versions of the platform (e.g., K8S) may also impact the resource consumption.

In this way, information technology (IT) departments can perform budget planning following the company's budget cycles, including how much to budget for each cycle. This can be significant, as KUBERNETES clusters distributed in different geolocations can have different unit prices for such resources in hybrid cloud and multi-cloud environments, which need to be known to prepare a budget plan. Given such differences, a strategy level consideration question for what resource plan to recommend can be whether the goal is minimizing total cost, or whether the goal needs to be based on the delivery speed, each of which can impact resource planning. Thus, for a budget approval process, designing a resource plan with different strategies such that management can make their decisions is desirable.

As will be understood, the technology described herein adapts to dynamic environment changes, including in one implementation by applying one or more models to make predictions based on historical resource consumption records, platform configuration changes (which are hidden from the historical data or from other forecasting), and target market demand data, which is not accessible from historical data. Because budgeting in hybrid cloud and multi-cloud environments each have a different cost structure, different optimization (cost, performance, and the like) policy can be applied in cost structure plans for enterprise (e.g., customer) management to decide. The overall resources needs can be divided into business cycles evenly, or with different deployment strategies to better fit with the dynamics of given markets.

Reference throughout this specification to “one embodiment,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. It also should be noted that terms used herein, such as “optimization,” “optimize” or “optimal” and the like (e.g., “maximize,” “minimize” and so on) only represent objectives to move towards a more optimal state, rather than necessarily obtaining ideal results.

It should be understood that any of the examples and/or descriptions herein are non-limiting. As one example, Kubernetes® is described as one suitable automated system for deployment, scaling, and management of containerized applications; notwithstanding, the technology described herein is not limited to Kubernetes® systems. Thus, any of the embodiments, example embodiments, concepts, structures, functionalities or examples described herein are non-limiting, and the technology may be used in various ways that provide benefits and advantages in computing and forecasting resource usage in general.

The subject disclosure will now be described more fully hereinafter with reference to the accompanying drawings in which example components, graphs and/or operations are shown. In the following description, for purposes of explanation, numerous specific details are set forth in order to provide a thorough understanding of the various embodiments. However, the subject disclosure may be embodied in many different forms and should not be construed as limited to the examples set forth herein.

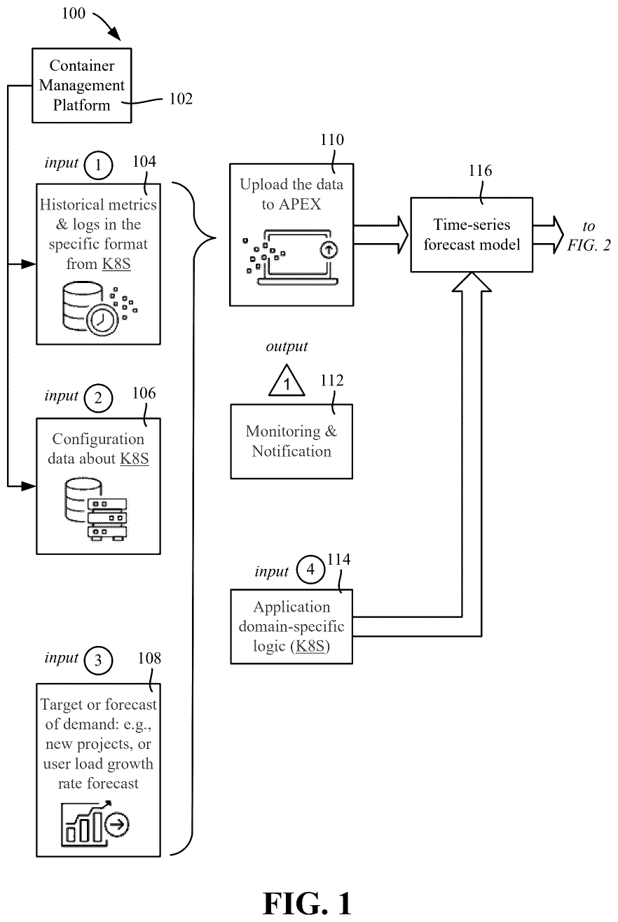

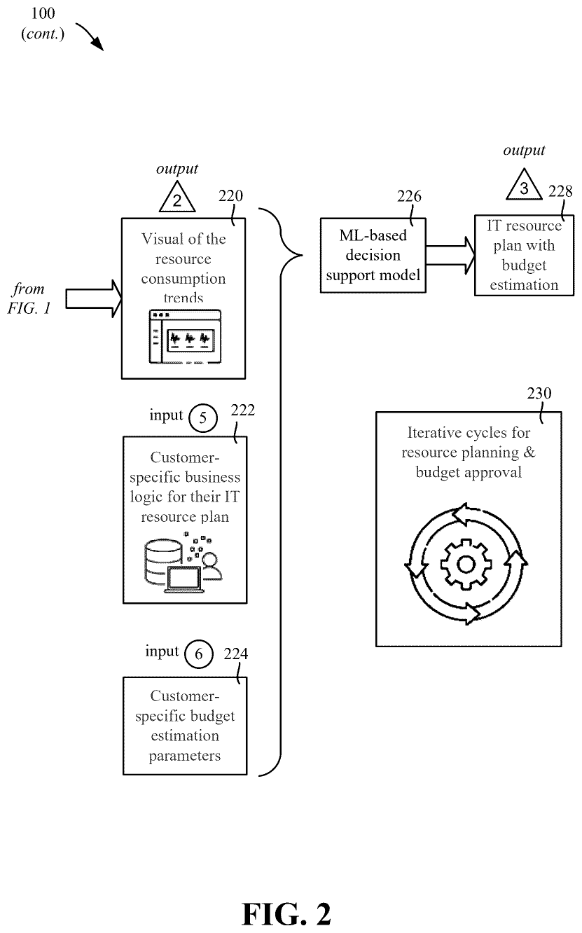

FIGS. 1 and 2 show an example system/architecture 100 that is based on a container management platform 102 (e.g., Kubenetes®, or K8S), from which historical resource usage metrics 104 (input (1)) and configuration change data 106 (input (2)) are accessed. In one implementation, the historical metrics and logs are in the specific format corresponding to K8S. A third input (input (3)) is target or forecast of demand (system load) data (block 108), e.g., obtained from marketing or the like, based on new projects, or user load growth rate forecast.

Block 110 represents uploading the data to a multi-cloud management platform, such as DELL APEX. Users or an automated process can perform the data upload. This data can be used as a basis for monitoring and notification (block 112/output (1)) as described herein.

In general, AI-driven technology as described herein offers accurate resource forecasts, enabling effective budgeting and optimized cloud spending, transforming resource planning, and empowering organizations to stay competitive and agile. APEX central engineering shares the same need, particularly to automate the scaling up of pivotal container service (PKS). For improved customer experience in the APEX console, a reliable quality of service (QoS) defined by SLA/SLO, consistent and measurable KPIs for APEX Customers, and proper resource planning by APEX engineering are valuable.

The AI service is based on a collection of time-series metrics and logs from a specific system (e.g., PKS) as input. The output is a multi-phase IT resource plan with budget estimates, directly suitable for an enterprise's IT process. For example, within the next three months, a forecast may suggest adding x TB of extra storage, y G of extra RAM, and z additional CPU cores, with an estimated budget of w. These AI services can be generalized to support customer self-service. Moreover, such AI services can be added to APEX offerings for APEX customers.

A fourth input (input (4), block 114) is related to application domain-specific logic, e.g., for K8S, and for example includes software version changes. Note that such changes can affect the forecast, because, for example, timeseries data collected with one version may be less efficient in terms of resource usage than the same resources used with a later version, including the version for which forecasting is to be based.

As described herein, the (properly weighted) input data (inputs (1)-(4)) are the basis for training and testing a timeseries resource consumption forecast model 116. Any or a combination of multiple popular models can be used, for example, ARIMA (autoregressive integrated moving average), STL (Seasonal and Trend Decomposition using LOESS (locally estimated scatterplot smoothing model), LSTM (deep learning with long-short term memory), FACEBOOK'S Prophet forecasting algorithm, or the like.

The system 100 depiction continues at FIG. 2, wherein the output 220 of the timeseries resource consumption forecast model 116 can be presented as visualization (shown as part of block 220 as output (2)). This can include trends, and the resource consumption forecast can be viewed against actual resource consumption data as new data comes in.

The resource consumption forecast data 220 can also be input, along with entity-specific (e.g., customer specific) business logic (block 222, input (5)) for the entity's IT resource plan and/or customer-specific budget estimation parameters (block 224, input (6)) to an ML-based decision support model 226. In one implementation, the result from the decision support model 226 is an IT resource plan with budget estimation 228, as described herein. Inputs (5) and (6) can be based on price per vendor, per location, business cycle, monthly, quarterly, random and so on.

In general, as represented by block 230, the overall resource forecasting, planning and budget process is iterative, e.g., corresponding to cycles for resource planning and budget approval. This can be on demand based on monitoring, or per quarter, per month and so on as determined by the entity (e.g., enterprise customer) using the platform.

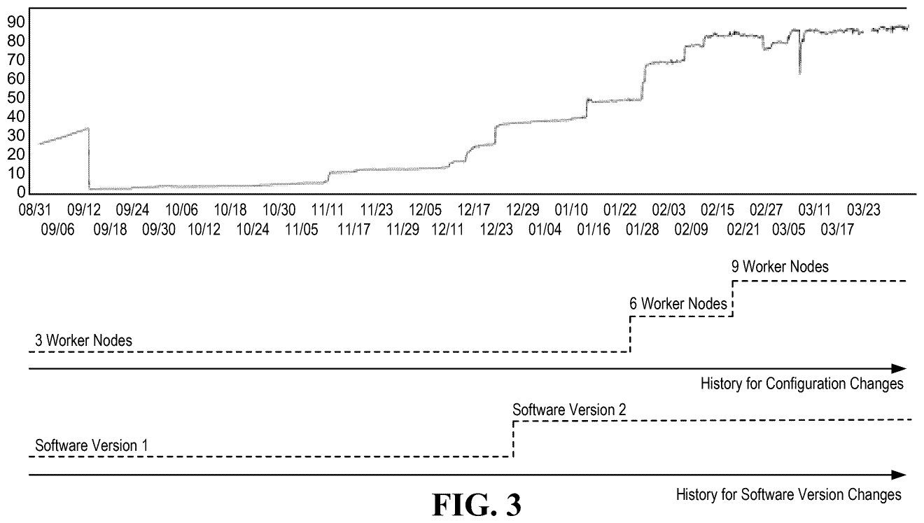

Turning to additional details of the example components/processes of FIGS. 1 and 2, a first part is data engineering, which is directed to preparing the historical training data. As described with reference to FIG. 1, the first input data is the historical resource consumption records. For example, FIG. 3 illustrates memory consumption for K8S (in terms of percentage used versus total memory). Note that the historical data goes into cycles with nodes, memory CPU as time series data, noting trends and other considerations, e.g., holidays are busy, the peak time is part of the data, resulting in the forecasted resources needed, which can be for the next month, six months and so on.

A problem is that the total memory, as with other resources such as CPU usage, disk (or other storage device, simply referred to as “disk” herein) usage, and network usage is not a constant value during the period of history. As the example of FIG. 3 shows, the lower portion of the diagram indicates that the total amount or memory was increased twice when more nodes were added to the K8S cluster. Therefore, the historical resource consumption needs to be weighted to reflect the total memory usage, as does CPU, disk, network and so on. Other configuration changes that can impact historical data can include changes to load balancing, policies and the like.

Another factor to consider is the impact of K8S version updates. For example, if an estimated resource consumption comparison between v1 and v2 is 95%, the new v2 of K8S consumes 5% less memory given the same load. This factor (input (4)) also needs to be considered (weighted) in the training data preparation, e.g., the weight needs to be calculated relative to the latest version (which is what the forecast is for) as the base, such as any v1-related historical consumption has a multiple with 1/95%=105.3%. Note that inputs (2) and (4) can correspond to per-resource increase ratios.

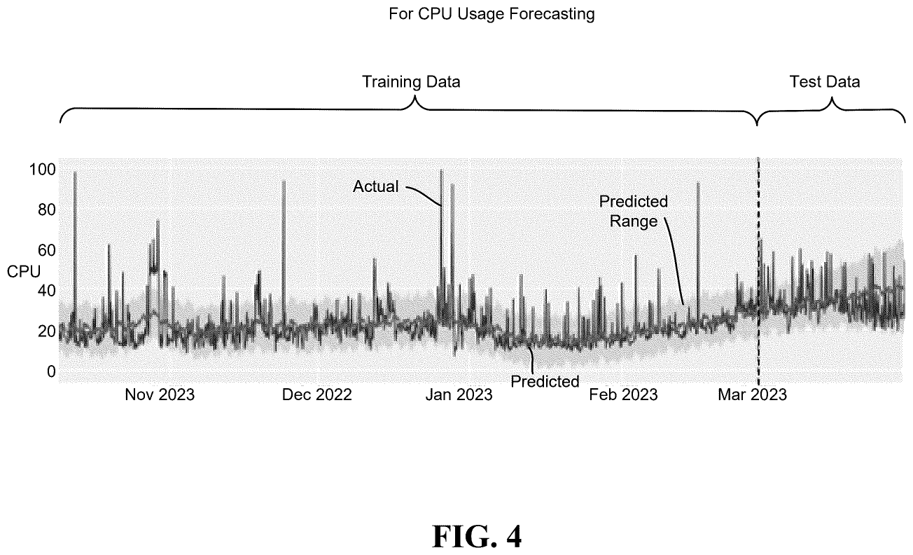

FIG. 4 shows an example of training data and test data for CPU usage forecasting. Forecasting with historical training data can be per metric, e.g., CPU usage over time such as six months of training/test data, used to forecast what CPU is needed (limits). The actual data, predicted data, and the predicted “confidence” range (the lightly shaded portion around the predicted data) can be used. The same concept applies to disk and memory, in which nodes can be added to meet increased capacity); the cost budget can be based on the predicted new nodes. Note that the symmetric mean absolute percentage error (SMAPE) can be used in the training:

$$SMAPE = \frac{1}{n} \times \sum \frac{\vert forecast value - actual value \vert}{( \vert actual value \vert + \vert forecast value \vert ) / 2}$$

Another part of data engineering is preparing the target system load training data, that is, preparing the training data based on expected system load. Here it can be assumed that a marketing team or other source has provided customer growth rate forecasting as input. The assumption is that such marketing or ordering forecasting can represent the expected system loads for K8S. There can be extra modeling techniques to get what is needed, e.g., system load forecasting based on customer behaviors. This corresponds to input (3), and includes concepts such as macro level signals, e.g., customer finances, overall climate, the market situation, which corresponds to a customer increase ratio.

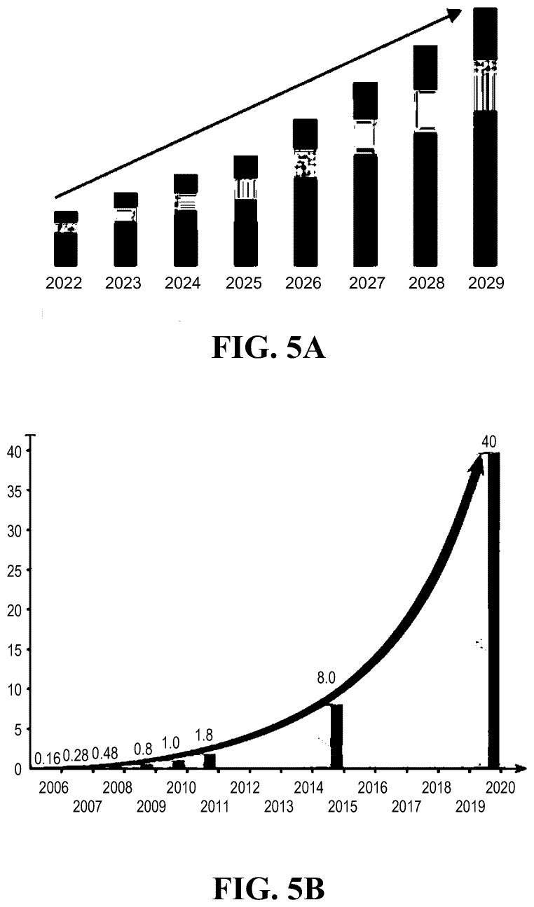

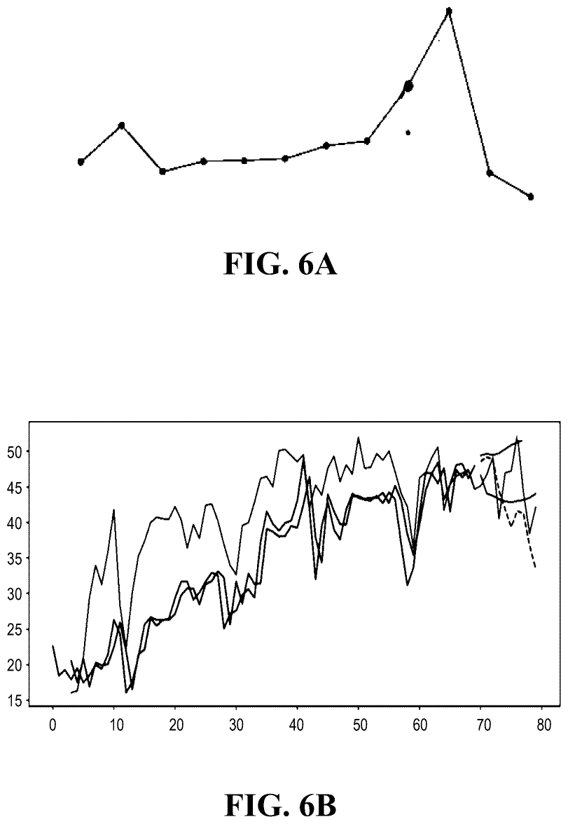

FIGS. 5A-6B illustrate various potential system load estimations, ranging from simple linear model (FIG. 5A), a more complex non-linear model (FIG. 5B), to complex seasonal pattern models (FIGS. 6A and 6B). The data engineering task here is to use such marketing forecasting to adjust the weight with the forecasting previously made. One approach is to calculate a related comparison index from the future time to current time. For example, with a yearly-based forecast, then the current year forecast number can be used as the base, translating the forecast of future years to be a percentage of current year, like 110%, 130%, or 90% if decreasing. The set of indexes can be used to adjust the forecast previously generated. Note that if there are K8S configuration changes planned in the future, then the historical data is adjusted based thereon for the future.

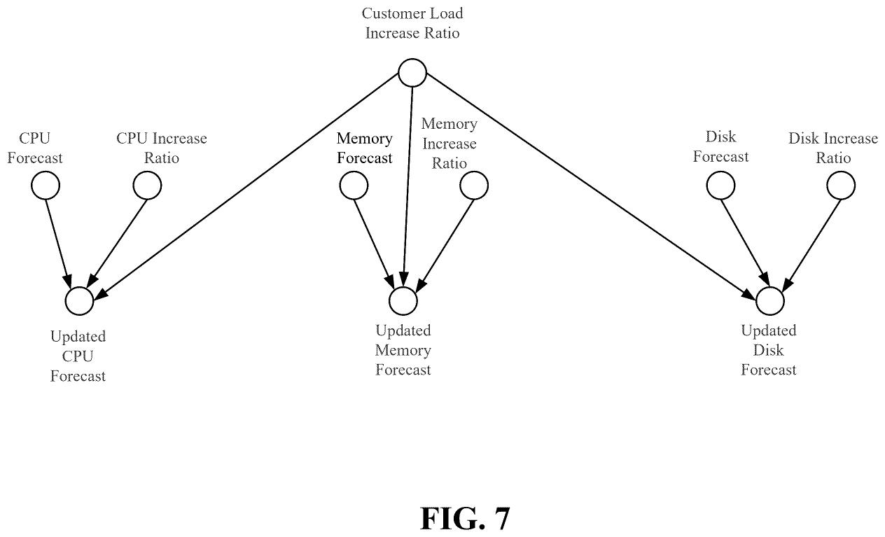

Bayesian network models can be used for adjusting the weight of historical data. More particularly, the above considerations (inputs (2), (3) and (4)) can be used to adjust the historical data or forecasting with proper weights due to these various factors, which can be implemented by a Bayesian network model. FIG. 7 shows a sample network diagram for how such variables may impact each other. Note that the weights may be estimated initially based on experience, and then learned with actual data over time.

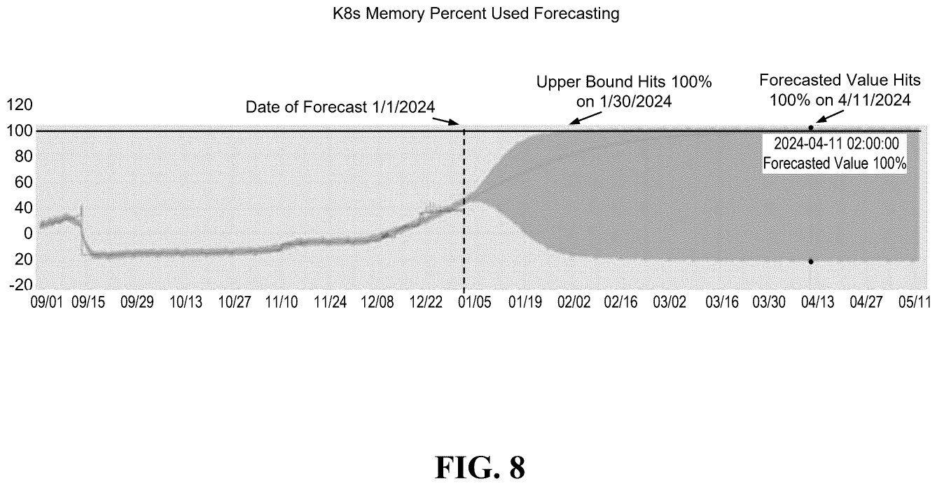

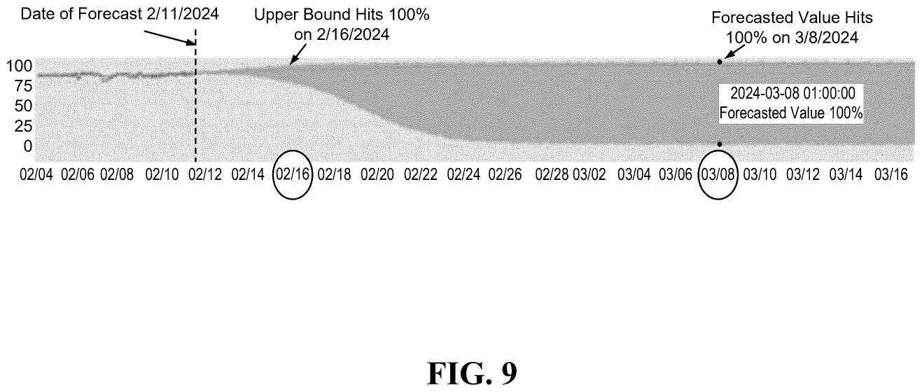

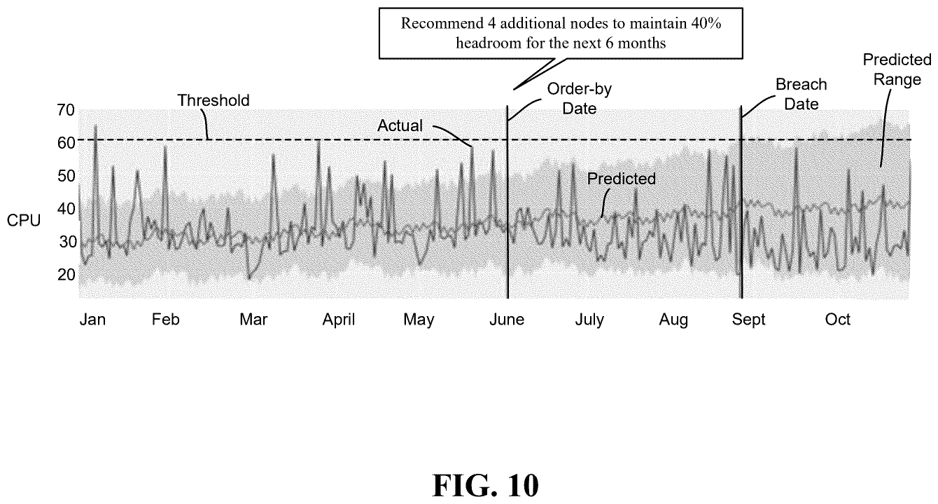

FIGS. 8 and 9 show examples of visualization and providing notification with the adjusted forecast generated as described herein. In general, visualization and notification let users know the forecasts. The examples of FIGS. 8 and 9 illustrate the results of memory consumption forecasting at cluster level and at node level, respectively. Note that the concept of an upper bound being reached by actual resource consumption after the forecast date can be used to trigger a notification, whereby monitoring can proactively prevent an issue.

The recommendation of needed resources can be divided into budget cycles. For example, based on the forecasting, the system can start recommending needed resources according to some criteria (e.g., minimum headroom=40%/threshold=60% as shown in FIG. 9. Consider further that the known deployment lead time is three months, as also illustrated in FIG. 9.

The recommended extra resources can be divided into budget cycles. For example, if quarterly, divide by four to get the extra resources for each quarter. The end users will decide the budget cycle frequency according to their organizational policy.

One extra feature that can be provided to an end-user entity is that they can also specify a strategy as to how to allocate resources into budget cycles. Examples include linear adjustment, divide by number of cycles evenly and round the numbers, or aggressive, in which users can also choose an aggressive strategy to get the needed resources in the early cycles. A conservative strategy is also possible, whereby an end-user can delay the adding of extra resources (to wait for the validation of customer growth forecasting and adjust later). Yet another strategy is automatic/adaptive, that is, let the system automatically monitor resource usage and adjust the plan in next available cycle.

Cost estimation and resource budget calculation can be part of the system, in which for multi-cloud and hybrid cloud environments, budget estimation is a complex process. There are various cost estimation calculators available per specific platform, however described herein is cost estimation and resource budget calculation solution based on these individual calculators, which can be aggregated into a total budget plan. One optional feature allows a user to set up strategy about the ratio across different cloud vendors or local cluster. For example, a fixed ratio between local and cloud vendor, like 50%:50%; this can be fixed for local due to limits, with any needed extra resources going to the cloud vendor, (which is useful for a situation in which load is changing dynamically). A strategy can be to minimize total cost by using the cheapest options, or alternatively, to maximizing the speed of availability with some guidance. There can be multiple version of budget plans generated with different chosen policy/parameters, such that management can compare and evaluate which strategy to follow (or switch to).

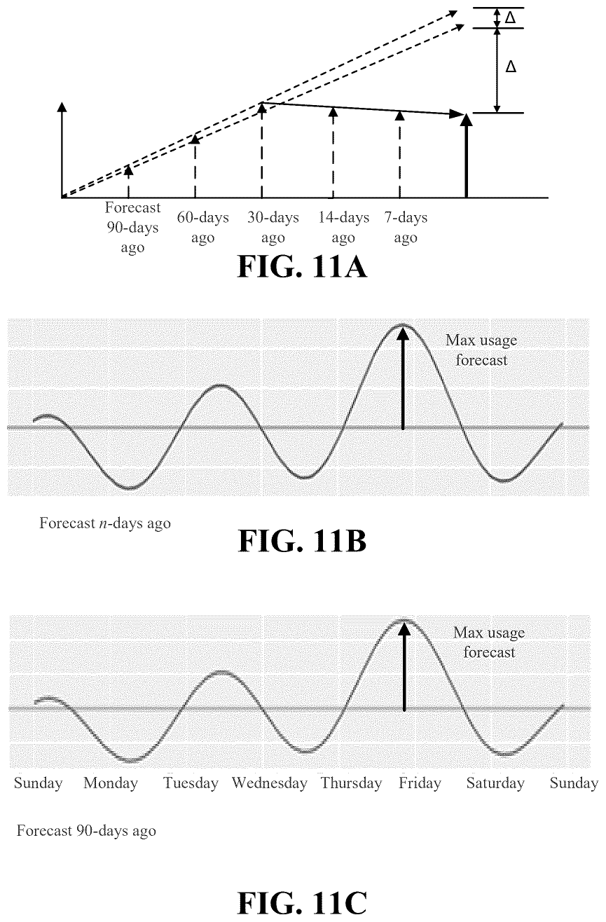

Execution and adjusting refer to resource planning and budget estimation being a never-ending process, in general. Therefore, continuously monitoring the actual resource usage against the forecasting is a valuable part of the system, e.g., to monitor for divergence of the actual resource consumption from the forecasted resource consumption. An adaptive alerting model is based on the on the change rate (e.g., how fast the memory growth rate increased), rather than relying on rules to trigger an alert. This is illustrated in FIGS. 11A-11C.

To summarize thus far, one implementation provides a comprehensive end-to-end automated Kubernetes® or other platform resource planning and budgeting system for hybrid cloud and multi-cloud environments. The system can incorporate Bayesian Network models for forecasting resources based on historical consumption, optimal budget structure policies (cost, performance, latency, and the like) to fit an organization's needs and market dynamics. The technology described herein can generate multiple versions of budget plans, e.g., with a stack-ranked list of policy parameters such that an organization can compare and evaluate the options to select their most desirable option.

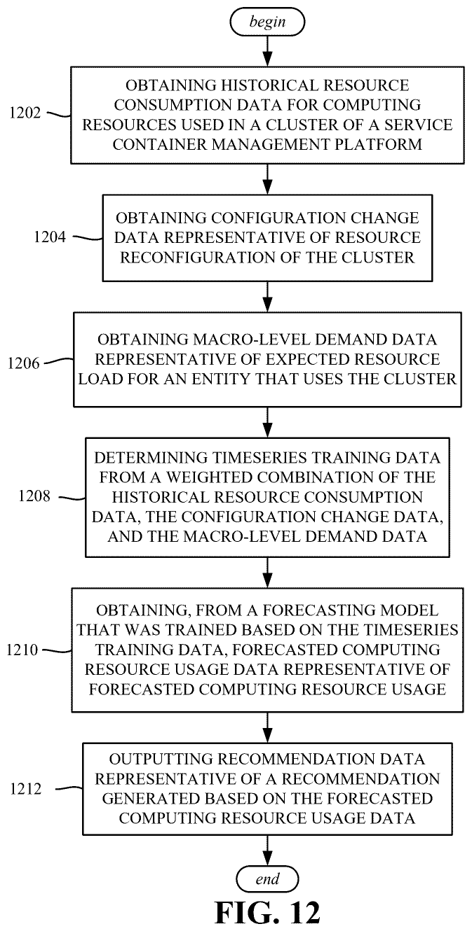

One or more implementations and embodiments can be embodied in a system, such as represented in the example operations of FIG. 12, and for example can include a memory that stores computer executable components and/or operations, and at least one processor that executes computer executable components and/or operations stored in the memory. Example operations can include operation 1202, which represents obtaining historical resource consumption data for computing resources used in a cluster of a service container management platform. Example operation 1204 represents obtaining configuration change data representative of resource reconfiguration of the cluster. Example operation 1206 represents obtaining macro-level demand data representative of expected resource load for an entity that uses the cluster.

Example operation 1208 represents determining timeseries training data from a weighted combination of the historical resource consumption data, the configuration change data, and the macro-level demand data. Example operation 1210 represents obtaining, from a forecasting model that was trained based on the timeseries training data, forecasted computing resource usage data representative of forecasted computing resource usage. Example operation 1212 represents outputting recommendation data representative of a recommendation generated based on the forecasted computing resource usage data.

The historical resource consumption data for the computing resources can include at least one of: central processing unit (CPU) usage data representative of CPU usage by the cluster, memory usage data representative of memory usage by the cluster, storage device usage data representative of storage device usage by the cluster, or network usage data representative of network usage by the cluster.

Determining the timeseries training can be performed by a Bayesian network model based on a first per-resource weight for the historical resource consumption data, a second per-resource weight for the configuration change data, and per-resource weight for the macro-level demand data.

Further operations can include modifying the first per-resource weight based on software version data for the service container management platform.

The service container management platform can include a Kubernetes system in which service containers are executed in one or more Kubernetes® pods.

The timeseries forecasting model can include an autoregressive integrated moving average model, a seasonal and trend decomposition using locally estimated scatterplot smoothing model, a deep learning with long-short term memory model, or a FACEBOOK Prophet forecasting model.

Further operations can include monitoring actual data relative to the forecasted computing resource usage data to determine whether a threshold upper bound has been reached, and, in response to the threshold upper bound being determining to have been reached, outputting a notification.

Further operations can include monitoring actual data relative to the forecasted computing resource usage data to determine a rate of change, and, in response to the rate of change being determined to satisfy a threshold rate of change, outputting a notification.

Further operations can include outputting a visualization that can include the forecasted computing resource usage data.

Outputting of the recommendation data can be iteratively repeated based on a budget cycle of the entity that uses the cluster.

Outputting of the recommendation data can include outputting an indication that at least one additional node is requested for the cluster.

The service container management platform can be a first instance of the service container management platform executing in a first cloud environment, and further can include a second instance of the service container management platform executing in a second cloud environment; further operations can include outputting, based on the recommendation data, a cost estimate based on a first cost estimate corresponding to the forecasted computing resource usage data with respect to the first cloud environment, and a second cost estimate corresponding to the forecasted computing resource usage data with respect to the second cloud environment.

The cost estimate can be determined based on at least one of: entity-specific business logic, or entity-specific budget estimation parameters.

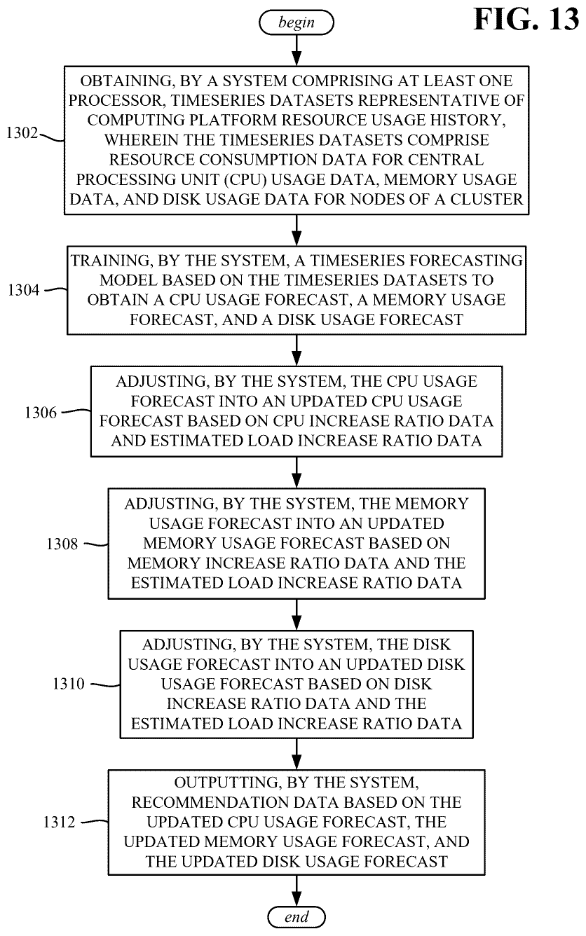

One or more example implementations and embodiments, such as corresponding to example operations of a method, are represented in FIG. 13. Example operation 1302 represents obtaining, by a system including at least one processor, timeseries datasets representative of computing platform resource usage history, wherein the timeseries datasets can include resource consumption data for central processing unit (CPU) usage data, memory usage data, and disk usage data for nodes of a cluster. Example operation 1304 represents training, by the system, a timeseries forecasting model based on the timeseries datasets to obtain a CPU usage forecast, a memory usage forecast, and a disk usage forecast. Example operation 1306 represents adjusting, by the system, the CPU usage forecast into an updated CPU usage forecast based on CPU increase ratio data and estimated load increase ratio data. Example operation 1308 represents adjusting, by the system, the memory usage forecast into an updated memory usage forecast based on memory increase ratio data and the estimated load increase ratio data. Example operation 1310 represents adjusting, by the system, the disk usage forecast into an updated disk usage forecast based on disk increase ratio data and the estimated load increase ratio data. Example operation 1312 represents outputting, by the system, recommendation data based on the updated CPU usage forecast, the updated memory usage forecast, and the updated disk usage forecast.

Further operations can include learning, by the system, a first set of relative weights for the CPU usage forecast, the CPU increase ratio data, and the estimated load increase ratio data, wherein the adjusting of the CPU usage forecast into the updated CPU usage forecast is based on the first set of weights, a second set of relative weights for the memory usage forecast, the memory increase ratio data, and the estimated load increase ratio data, wherein the adjusting of the memory usage forecast into the updated memory usage forecast is based on the second set of weights, and a third set of relative weights for the disk usage forecast, the disk increase ratio data, and the estimated load increase ratio data, wherein the adjusting of the disk usage forecast into the updated disk usage forecast is based on the third set of weights.

Further operations can include monitoring, by the system, actual CPU usage relative to the updated CPU usage forecast, to output a CPU-related notification in response to at least one of: the actual CPU usage increasing at a rate that exceeds a threshold CPU usage increase rate, or the actual CPU usage reaching an upper bound headroom threshold, monitoring, by the system, actual memory usage relative to the updated memory usage forecast, to output a memory-related notification in response to at least one of: the actual memory usage increasing at a rate that exceeds a threshold memory usage increase rate, or the actual memory usage reaching an upper bound headroom threshold, and monitoring, by the system, actual disk usage relative to the updated disk usage forecast, to output a disk-related notification in response to at least one of: the actual disk usage increasing at a rate that exceeds a threshold disk usage increase rate, or the actual disk usage reaching an upper bound headroom threshold.

The recommendation data can be first recommendation data, and further operations can include outputting, by the system, second recommendation data based on a budget cycle of the entity associated with the nodes of a cluster the cluster.

Further operations can include determining, by the system, a number of one or more additional nodes for the cluster based on the recommendation data, and outputting, by the system, a cost estimate based on the number of the one or more additional nodes.

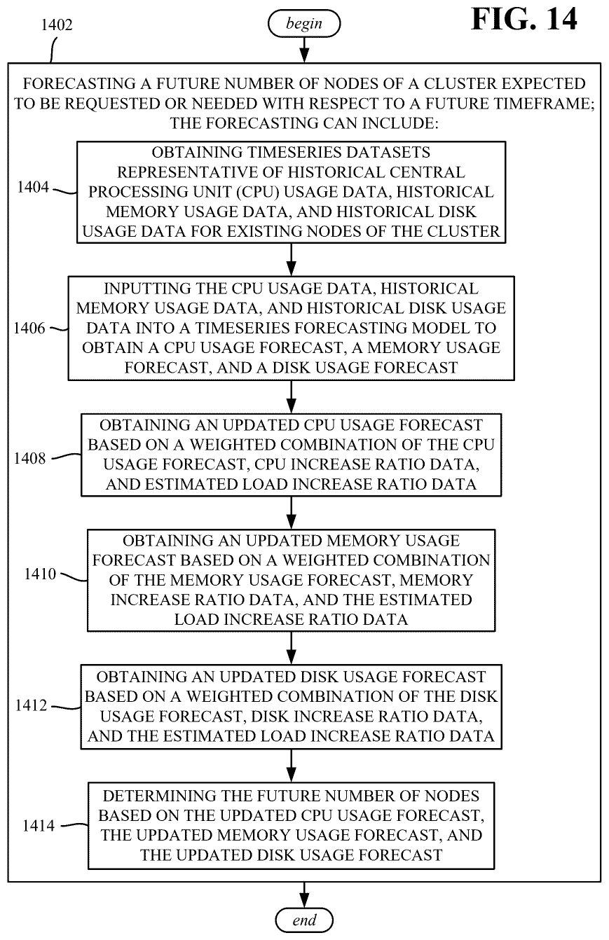

FIG. 14 summarizes various example operations, e.g., corresponding to a machine-readable medium, including executable instructions that, when executed by a processor, that, when executed by at least one processor, facilitate performance of operations. Example operation 1402 represents forecasting a future number of nodes of a cluster expected to be requested or needed with respect to a future timeframe. The forecasting can include operations 1404-1414. Example operation 1404 represents obtaining timeseries datasets representative of historical central processing unit (CPU) usage data, historical memory usage data, and historical disk usage data for existing nodes of the cluster. Example operation 1406 represents inputting the CPU usage data, historical memory usage data, and historical disk usage data into a timeseries forecasting model to obtain a CPU usage forecast, a memory usage forecast, and a disk usage forecast. Example operation 1408 represents obtaining an updated CPU usage forecast based on a weighted combination of the CPU usage forecast, CPU increase ratio data, and estimated load increase ratio data. Example operation 1410 represents obtaining an updated memory usage forecast based on a weighted combination of the memory usage forecast, memory increase ratio data, and the estimated load increase ratio data. Example operation 1412 represents obtaining an updated disk usage forecast based on a weighted combination of the disk usage forecast, disk increase ratio data, and the estimated load increase ratio data. Example operation 1414 represents determining the future number of nodes based on the updated CPU usage forecast, the updated memory usage forecast, and the updated disk usage forecast.

Further operations can include monitoring actual CPU usage relative to the updated CPU usage forecast, monitoring actual memory usage relative to the updated memory usage, and monitoring actual disk usage relative to the updated disk usage forecast.

As can be seen, the technology described herein provides a system for IT resource planning and budgeting, e.g., for K8S, that is based on AI/ML-forecasting of future resource needs. This is in contrast to existing solutions from cloud vendors who provide some platform-specific budget/cost monitoring and control, but not for an end-to-end ML-based complete solution for hybrid cloud, multi-cloud environments.

The technology described herein is adaptive to the dynamic environment changes. Specifically, this includes applying machine learning models to make predictions based on historical resource consumption records, as well as factoring in configuration changes and target market demands, along with any version updates. As each hybrid cloud and multi-cloud environment has a different cost structure, different optimization options are considered. The overall resource needs can then be divided into business cycles in various ways, and/or with different deployment strategies to better fit with the dynamics of the markets.

The technology described herein can streamline resource management processes, enhance decision-making capabilities, and contribute to a more cost-effective and agile IT infrastructure. The system can help IT teams accurately estimate future resource consumption needs based on historical data, configuration changes, and business demands. This ensures that computing resources are allocated more optimally, avoiding overprovisioning or underutilization. By accurately forecasting resource needs and taking into account Kubernetes® configuration changes, the system helps maximize resource utilization and minimizes waste. With the ability to forecast resource needs based on different versions of Kubernetes® and business growth targets, the system can support the scalability requirements of applications effectively.

The system enables IT teams to perform budget planning aligned with the company's budget cycles. It provides insights into how much budget should be allocated for each cycle, considering the projected resource needs. By recommending resource plans that minimize total costs, the system assists in making informed decisions that align with cost-saving objectives. In hybrid cloud and multi-cloud environments, where unit prices for resources can differ across locations, the system can help optimize costs by taking into account these variations. For scenarios where delivery speed is a significant consideration, the system can adjust the resource planning strategy accordingly, ensuring that the applications meet performance targets. Further, as Kubernetes® and cloud environments evolve, the system can be updated to support new versions and technologies, ensuring it remains relevant and beneficial in the long term.

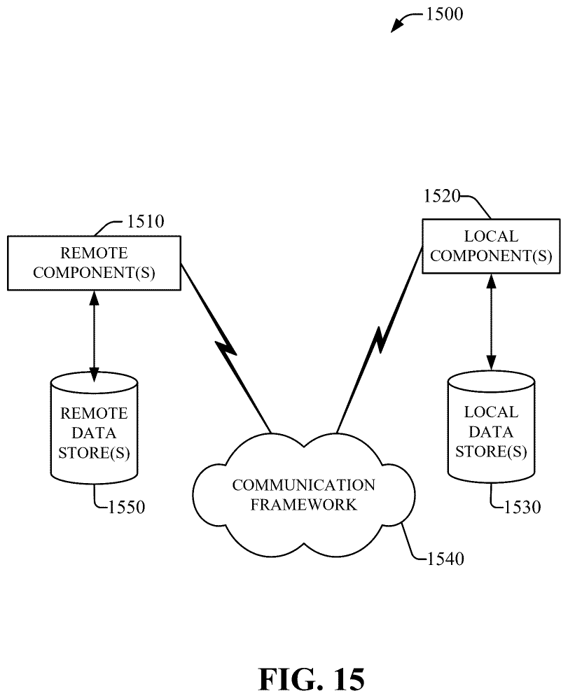

FIG. 15 is a schematic block diagram of a computing environment 1500 with which the disclosed subject matter can interact. The system 1500 can include one or more remote component(s) 1510. The remote component(s) 1510 can be hardware and/or software (e.g., threads, processes, computing devices). In some embodiments, remote component(s) 1510 can be a distributed computer system, connected to a local automatic scaling component and/or programs that use the resources of a distributed computer system, via communication framework 1540. Communication framework 1540 can comprise wired network devices, wireless network devices, mobile devices, wearable devices, radio access network devices, gateway devices, femtocell devices, servers, etc.

The system 1500 also comprises one or more local component(s) 1520. The local component(s) 1520 can be hardware and/or software (e.g., threads, processes, computing devices). In some embodiments, local component(s) 1520 can comprise an automatic scaling component and/or programs that communicate/use the remote resources 1510, etc., connected to a remotely located distributed computing system via communication framework 1540.

One possible communication between a remote component(s) 1510 and a local component(s) 1520 can be in the form of a data packet adapted to be transmitted between two or more computer processes. Another possible communication between a remote component(s) 1510 and a local component(s) 1520 can be in the form of circuit-switched data adapted to be transmitted between two or more computer processes in radio time slots. The system 1500 comprises a communication framework 1540 that can be employed to facilitate communications between the remote component(s) 1510 and the local component(s) 1520, and can comprise an air interface, e.g., Uu interface of a UMTS network, via a long-term evolution (LTE) network, etc. Remote component(s) 1510 can be operably connected to one or more remote data store(s) 1550, such as a hard drive, solid state drive, SIM card, device memory, etc., that can be employed to store information on the remote component(s) 1510 side of communication framework 1540. Similarly, local component(s) 1520 can be operably connected to one or more local data store(s) 1530, that can be employed to store information on the local component(s) 1520 side of communication framework 1540.

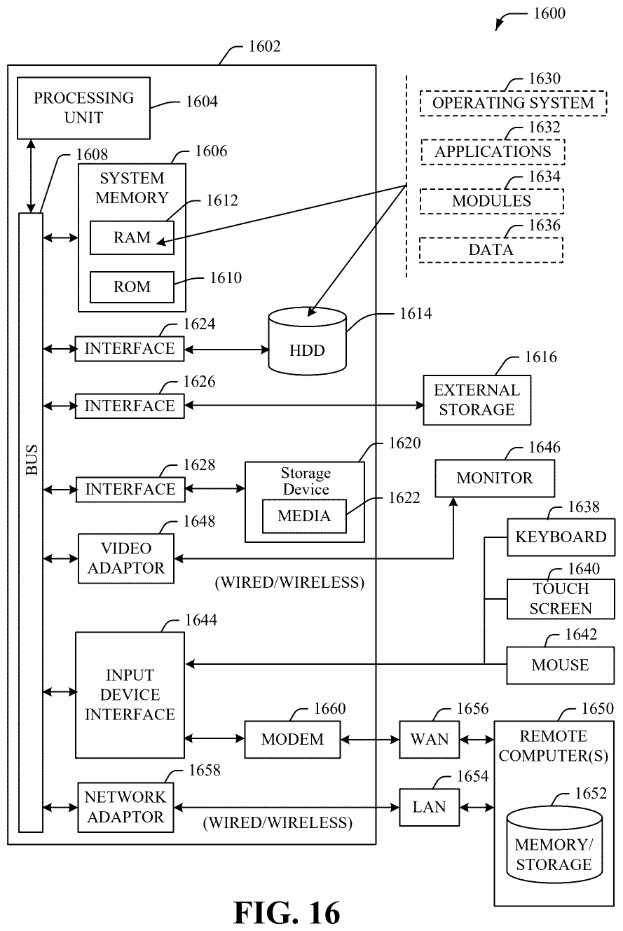

In order to provide additional context for various embodiments described herein, FIG. 16 and the following discussion are intended to provide a brief, general description of a suitable computing environment 1600 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 16, the example environment 1600 for implementing various implementations and embodiments described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), and can include one or more external storage devices 1616 (e.g., a magnetic floppy disk drive (FDD) 1616, a memory stick or flash drive reader, a memory card reader, etc.). While the internal HDD 1614 is illustrated as located within the computer 1602, the internal HDD 1614 can also be configured for external use in a suitable chassis (not shown). Additionally, while not shown in environment 1600, a solid state drive (SSD) could be used in addition to, or in place of, an HDD 1614.

Other internal or external storage can include at least one other storage device 1620 with storage media 1622 (e.g., a solid state storage device, a nonvolatile memory device, and/or an optical disk drive that can read or write from removable media such as a CD-ROM disc, a DVD, a BD, etc.). The external storage 1616 can be facilitated by a network virtual machine. The HDD 1614, external storage device(s) 1616 and storage device (e.g., drive) 1620 can be connected to the system bus 1608 by an HDD interface 1624, an external storage interface 1626 and a drive interface 1628, respectively.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the .NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1694 serial port, a game port, a USB port, an IR interface, a BLUETOOTH® interface, etc.

A monitor 1646 or other type of display device can be also connected to the system bus 1608 via an interface, such as a video adapter 1648. In addition to the monitor 1646, a computer typically includes other peripheral output devices (not shown), such as speakers, printers, etc.

The computer 1602 can operate in a networked environment using logical connections via wired and/or wireless communications to one or more remote computers, such as a remote computer(s) 1650. The remote computer(s) 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 and/or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the Internet.

When used in a LAN networking environment, the computer 1602 can be connected to the local network 1654 through a wired and/or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the Internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. It will be appreciated that the network connections shown are examples and other means of establishing a communications link between the computers can be used.

When used in either a LAN or WAN networking environment, the computer 1602 can access cloud storage systems or other network-based storage systems in addition to, or in place of, external storage devices 1616 as described above. Generally, a connection between the computer 1602 and a cloud storage system can be established over a LAN 1654 or WAN 1656 e.g., by the adapter 1658 or modem 1660, respectively. Upon connecting the computer 1602 to an associated cloud storage system, the external storage interface 1626 can, with the aid of the adapter 1658 and/or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
at least one processor; and
at least one memory that stores executable instructions that, when executed by the at least one processor, facilitate performance of operations, the operations comprising:
obtaining historical resource consumption data for computing resources used in a cluster of a service container management platform;
obtaining configuration change data representative of resource reconfiguration of the cluster;
obtaining macro-level demand data representative of expected resource load for an entity that uses the cluster;
determining timeseries training data from a weighted combination of the historical resource consumption data, the configuration change data, and the macro-level demand data;
obtaining, from a forecasting model that was trained based on the timeseries training data, forecasted computing resource usage data representative of forecasted computing resource usage; and
outputting recommendation data representative of a recommendation generated based on the forecasted computing resource usage data.

2. The system of claim 1, wherein the historical resource consumption data for the computing resources comprises at least one of: central processing unit (CPU) usage data representative of CPU usage by the cluster, memory usage data representative of memory usage by the cluster, storage device usage data representative of storage device usage by the cluster, or network usage data representative of network usage by the cluster.

3. The system of claim 1, wherein the determining of the timeseries training is performed by a Bayesian network model based on a first per-resource weight for the historical resource consumption data, a second per-resource weight for the configuration change data, and per-resource weight for the macro-level demand data.

4. The system of claim 3, wherein the operations further comprise modifying the first per-resource weight based on software version data for the service container management platform.

5. The system of claim 1, wherein the service container management platform comprises a Kubernetes system in which service containers are executed in one or more Kubernetes® pods.

6. The system of claim 1, wherein the timeseries forecasting model comprises an autoregressive integrated moving average model, a seasonal and trend decomposition using locally estimated scatterplot smoothing model, a deep learning with long-short term memory model, or a FACEBOOK Prophet forecasting model.

7. The system of claim 1, wherein the operations further comprise monitoring actual data relative to the forecasted computing resource usage data to determine whether a threshold upper bound has been reached, and, in response to the threshold upper bound being determining to have been reached, outputting a notification.

8. The system of claim 1, wherein the operations further comprise monitoring actual data relative to the forecasted computing resource usage data to determine a rate of change, and, in response to the rate of change being determined to satisfy a threshold rate of change, outputting a notification.

9. The system of claim 1, wherein the operations further comprise outputting a visualization comprising the forecasted computing resource usage data.

10. The system of claim 1, wherein the outputting of the recommendation data is iteratively repeated based on a budget cycle of the entity that uses the cluster.

11. The system of claim 1, wherein the outputting of the recommendation data comprises outputting an indication that at least one additional node is requested for the cluster.

12. The system of claim 1, wherein the service container management platform is a first instance of the service container management platform executing in a first cloud environment, and further comprising a second instance of the service container management platform executing in a second cloud environment, wherein the operations further comprise outputting, based on the recommendation data, a cost estimate based on a first cost estimate corresponding to the forecasted computing resource usage data with respect to the first cloud environment, and a second cost estimate corresponding to the forecasted computing resource usage data with respect to the second cloud environment.

13. The system of claim 1, wherein the cost estimate is determined based on at least one of: entity-specific business logic, or entity-specific budget estimation parameters.

14. A method, comprising:
obtaining, by a system comprising at least one processor, timeseries datasets representative of computing platform resource usage history, wherein the timeseries datasets comprise resource consumption data for central processing unit (CPU) usage data, memory usage data, and disk usage data for nodes of a cluster;
training, by the system, a timeseries forecasting model based on the timeseries datasets to obtain a CPU usage forecast, a memory usage forecast, and a disk usage forecast;
adjusting, by the system, the CPU usage forecast into an updated CPU usage forecast based on CPU increase ratio data and estimated load increase ratio data;
adjusting, by the system, the memory usage forecast into an updated memory usage forecast based on memory increase ratio data and the estimated load increase ratio data;
adjusting, by the system, the disk usage forecast into an updated disk usage forecast based on disk increase ratio data and the estimated load increase ratio data; and
outputting, by the system, recommendation data based on the updated CPU usage forecast, the updated memory usage forecast, and the updated disk usage forecast.

15. The method of claim 14, further comprising learning, by the system:
a first set of relative weights for the CPU usage forecast, the CPU increase ratio data, and the estimated load increase ratio data, wherein the adjusting of the CPU usage forecast into the updated CPU usage forecast is based on the first set of weights;
a second set of relative weights for the memory usage forecast, the memory increase ratio data, and the estimated load increase ratio data, wherein the adjusting of the memory usage forecast into the updated memory usage forecast is based on the second set of weights; and
a third set of relative weights for the disk usage forecast, the disk increase ratio data, and the estimated load increase ratio data, wherein the adjusting of the disk usage forecast into the updated disk usage forecast is based on the third set of weights.

16. The method of claim 14, further comprising:
monitoring, by the system, actual CPU usage relative to the updated CPU usage forecast, to output a CPU-related notification in response to at least one of: the actual CPU usage increasing at a rate that exceeds a threshold CPU usage increase rate, or the actual CPU usage reaching an upper bound headroom threshold;
monitoring, by the system, actual memory usage relative to the updated memory usage forecast, to output a memory-related notification in response to at least one of: the actual memory usage increasing at a rate that exceeds a threshold memory usage increase rate, or the actual memory usage reaching an upper bound headroom threshold; and
monitoring, by the system, actual disk usage relative to the updated disk usage forecast, to output a disk-related notification in response to at least one of: the actual disk usage increasing at a rate that exceeds a threshold disk usage increase rate, or the actual disk usage reaching an upper bound headroom threshold.

17. The method of claim 14, wherein the recommendation data is first recommendation data, and further comprising outputting, by the system, second recommendation data based on a budget cycle of the entity associated with the nodes of a cluster the cluster.

18. The method of claim 14, further comprising determining, by the system, a number of one or more additional nodes for the cluster based on the recommendation data, and outputting, by the system, a cost estimate based on the number of the one or more additional nodes.

19. A non-transitory machine-readable medium, comprising executable instructions that, when executed by at least one processor, facilitate performance of operations, the operations comprising:
forecasting a future number of nodes of a cluster expected to be requested or needed with respect to a future timeframe, the forecasting comprising:
obtaining timeseries datasets representative of historical central processing unit (CPU) usage data, historical memory usage data, and historical disk usage data for existing nodes of the cluster;
inputting the CPU usage data, historical memory usage data, and historical disk usage data into a timeseries forecasting model to obtain a CPU usage forecast, a memory usage forecast, and a disk usage forecast;
obtaining an updated CPU usage forecast based on a weighted combination of the CPU usage forecast, CPU increase ratio data, and estimated load increase ratio data;
obtaining an updated memory usage forecast based on a weighted combination of the memory usage forecast, memory increase ratio data, and the estimated load increase ratio data;
obtaining an updated disk usage forecast based on a weighted combination of the disk usage forecast, disk increase ratio data, and the estimated load increase ratio data; and
determining the future number of nodes based on the updated CPU usage forecast, the updated memory usage forecast, and the updated disk usage forecast.

20. The non-transitory machine-readable medium of claim 19, wherein the operations further comprise monitoring actual CPU usage relative to the updated CPU usage forecast, monitoring actual memory usage relative to the updated memory usage, and monitoring actual disk usage relative to the updated disk usage forecast.
